(19) United States
(12) Patent Application Publication
(10) Pub. No.: US 2011/0247892 A1
(43) Pub. Date: Oct. 13, 2011

(54) NOISE REDUCING DEVICE FOR TIMING CHAIN OF DIESEL ENGINE

(75) Inventor: Byunghwan JUNG, Gwangmyeong-si (KR)

(73) Assignees: Kia Motors Corporation, Seoul (KR); Hyundai Motor Company, Seoul (KR)

(21) Appl. No.: 12/758,364

(22) Filed: Apr. 12, 2010

(51) Int. Cl. F16F 15/00

(52) U.S. Cl. 181/207

(57) ABSTRACT

The present invention has a guide preventing radial vibration of a high-pressure pump sprocket engaged with a timing chain to transmit rotational power to from the timing chain to a high-pressure pump driving shaft and a guide formed on a timing chain cover to interact with the guide, in order to provide a noise reducing device for a timing chain of a diesel engine that can improve engagement between the high-pressure pump sprocket and the timing chain and effectively reduce operational noise generated in driving the timing chain, by appropriately supporting the high-pressure pump sprocket integrally rotatably fitted on the high-pressure pump driving shaft radially against the timing chain cover to prevent bending vibration of the high-pressure pump driving shaft.

### BACKGROUND OF THE INVENTION

1. Field of the Invention

The present invention relates to a timing chain of a diesel engine, particularly a noise reducing device for a timing chain of a diesel engine that reduces noise generated in driving the timing chain by improving engagement between the timing chain and the sprocket, by radially supporting the sprocket with the timing chain wound against the timing chain cover.

2. Description of Related Art

In timing chain systems of diesel engines generally used for vehicle in the related art, as shown in FIG. 1, a high-pressure pump sprocket 2 is linked to a crank sprocket 1 by a timing chain 3 to be integrally rotatable in a diesel engine and a cam sprocket 4 is linked to high-pressure pump sprocket 2 by timing chain 3 to be integrally rotatable.

A roller chain, a bush chain, and a silence chain are used as timing chain 3, but the roller chain is disadvantageous in durability and the silence chain is disadvantageous in manufacturing cost, such that the bush chain is commonly used.

Timing chain 3 implemented by the bush chain in the related art makes a loud noise due to engagement between the chain and the sprocket in driving the engine, thereby deteriorating NVH performance of vehicles.

That is, as shown in the cross-sectional view of FIG. 2, high-pressure pump sprocket 2 is fitted on a driving shaft 5 of a high-pressure pump to be integrally rotated and driving shaft 5 of the high-pressure pump protrudes through a timing chain cover 6, such that as crank sprocket 1 of the diesel engine is rotated by driving the diesel engine, high-pressure pump sprocket 2 is rotated by timing chain 3 to operating the high-pressure pump, in which tensile force is exerted in timing chain 3 and transmitted to driving shaft 5 of the high pressure pump through the high-pressure pump sprocket, such that bending vibration is generated in driving shaft 5 and interferes with smooth rolling contact between the sprocket and the timing chain, which causes engagement noise.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a noise reducing device for a timing chain of a diesel engine that can effectively reduce operational noise generated when the timing chain is operated, by appropriately supporting a high-pressure pump sprocket rotatably fitted on a high-pressure pump driving shaft radially against a timing chain to prevent bending vibration of the high-pressure pump driving shaft and improve engagement between the high-pressure pump sprocket and the timing chain.

An aspect of the present invention provides a noise reducing device for a timing chain of a diesel engine that has a guide preventing radial vibration of a high-pressure pump sprocket engaged with a timing chain to transmit rotational power of the timing chain to a high-pressure pump driving shaft, and a guide formed on a timing chain cover to interact with the guide.

Preferably, the guides are formed in a ring shape and any one of the guides is inserted inside the other guide with a gap therebetween.

The ring-shaped guide of the timing chain cover is larger in diameter than the ring-shaped guide of the high-pressure pump sprocket.

The timing chain cover is equipped with an oil jet pipe to supply lubricant to the gap.

According to the noise reducing device for a timing chain of a diesel engine of the present invention, when the high-pressure pump sprocket fitted on the high-pressure pump driving shaft is radially vibrated by tensile force exerted in the timing chain, the ring-shaped guide formed on the timing chain cover and the ring-shape guide formed on the high-pressure pump sprocket effectively prevents the high-pressure pump sprocket from radially vibrating, such that it is possible to improve engagement between the high-pressure pump sprocket and the timing chain to implement good power transmission and it is also possible to effectively reduce operational noise of the timing chain due to bad engagement, and as a result, the NVH performance of a vehicle is improved.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view when sprockets are linked by a timing chain according to the related art.

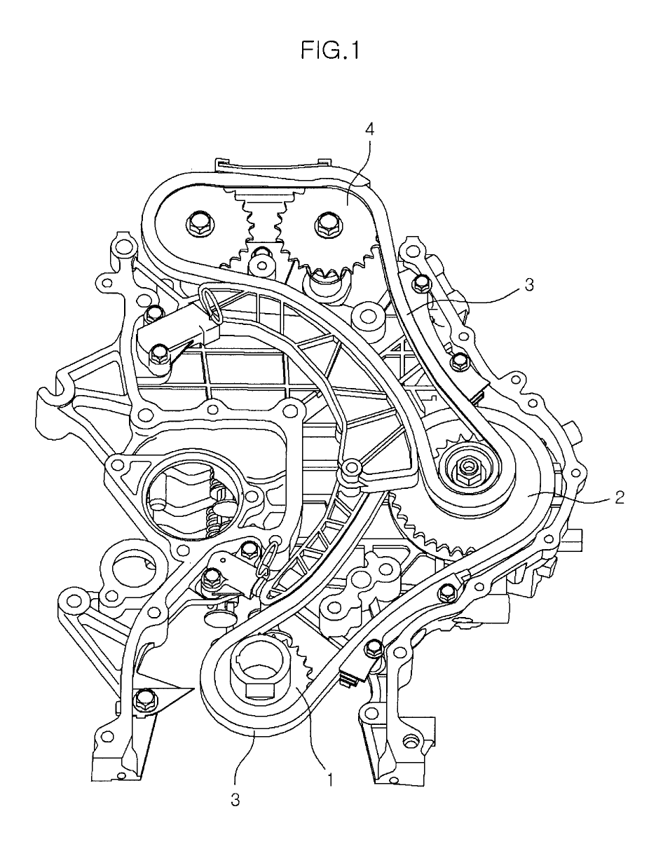

FIG. 2 is a cross-sectional view when a high-pressure pump sprocket is fitted on a high-pressure pump driving shaft according to the related art.

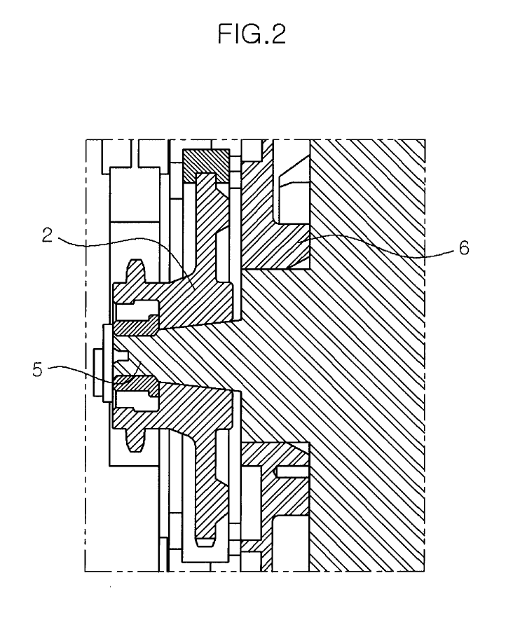

FIG. 3 is a perspective view of a noise reducing device for a timing chain of a diesel engine according to the present invention.

FIG. 4 is a cross-sectional view when a high-pressure pump sprocket equipped with a noise reducing device for a timing chain of a diesel engine according to the present invention is fitted on a high-pressure pump driving shaft.

FIG. 5 is a view illustrating the configuration of an oil supplier according to the present invention.

FIG. 6 is a graph comparing operational noise of timing chains of the related art and the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Embodiments of the present invention will be described hereafter in detail with reference to the accompanying drawings.

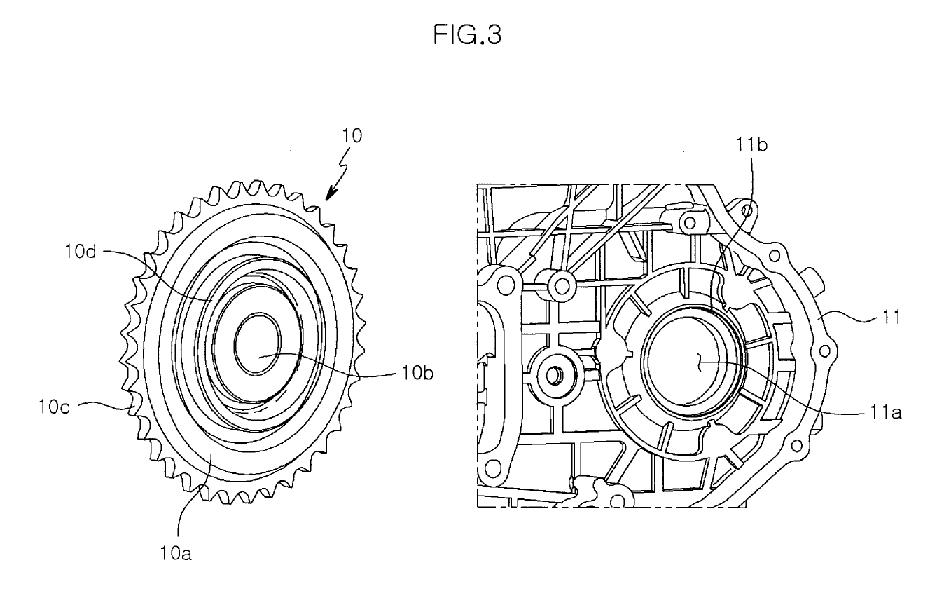

FIG. 3 shows a perspective view and a cross-sectional view illustrating the configuration of a noise reducing device for a timing chain of a diesel engine according to the present invention, in which a high-pressure pump sprocket t10 has a circular sprocket body 10a, a hole 10b formed through the center of sprocket body 10a to fit a high-pressure pump driving shaft, and a plurality of teeth 10c formed around the circumference of sprocket body 10a.

A ring-shaped guide 10d axially integrally protrudes outside along the circumference at the outside radially from hole 10b.

Further, a timing chain cover 11 covering and protecting the timing chain driving the sprockets has a hole 11a to fit high-pressure pump driving shaft 12, and a ring-shaped guide 11b axially integrally protrudes outside along the circumference at the outside radially from hole 11a and has a larger diameter than ring-shaped guide 10d of the high-pressure sprocket.

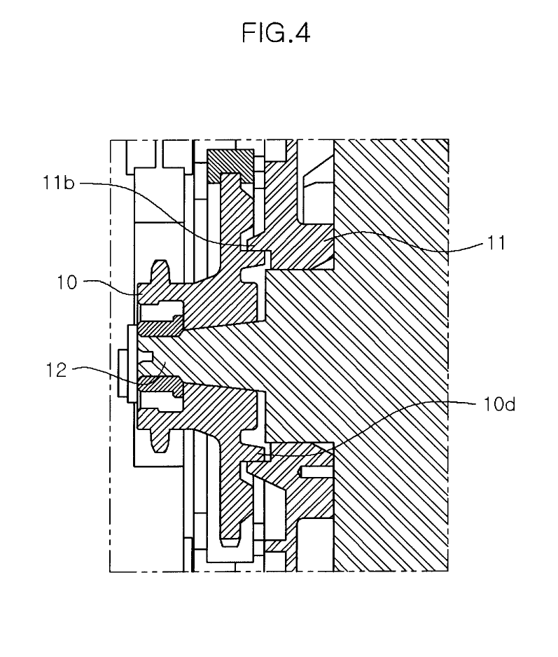

Accordingly, as shown in the cross-sectional view in FIG. 4, high-pressure pump driving shaft 12 is fitted in hole 11a of timing chain 11 and high-pressure pump sprocket 10 is fitted on driving shaft 12 to be integrally rotatable in order to transmit rotational force of the timing chain, in which ring-shaped guide 10d of high-pressure pump sprocket 10 is inserted inside ring-shaped guide 11b of timing chain cover 11.

When ring-shaped guide 10d of the high-pressure pump sprocket is inserted inside ring-shaped guide 11b of timing chain cover 11, a gap of about 30 to 60 μm is defined between the guides, and the size of guides 10d and 11b are appropriately set for this configuration.

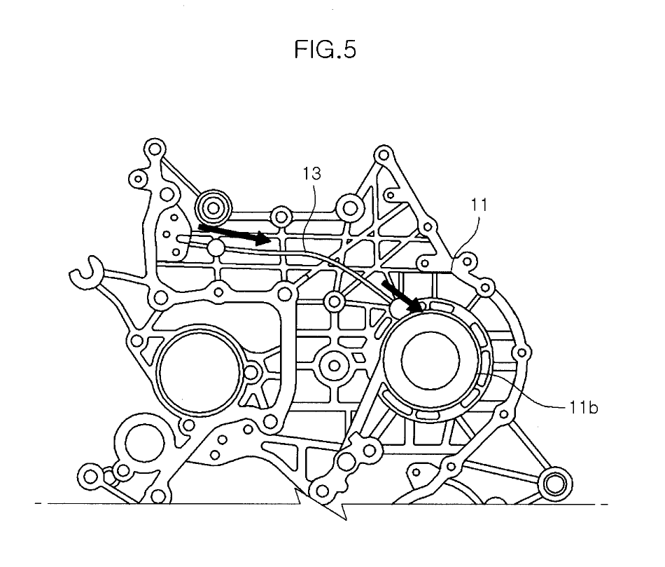

Further, as shown in detail in FIG. 5, timing chain cover 11 is equipped with an oil jet pipe 13 to supply oil for lubrication in the gap between the guides, such that engine oil is appropriately supplied to the gap through oil jet pipe 13 and the guides are lubricated.

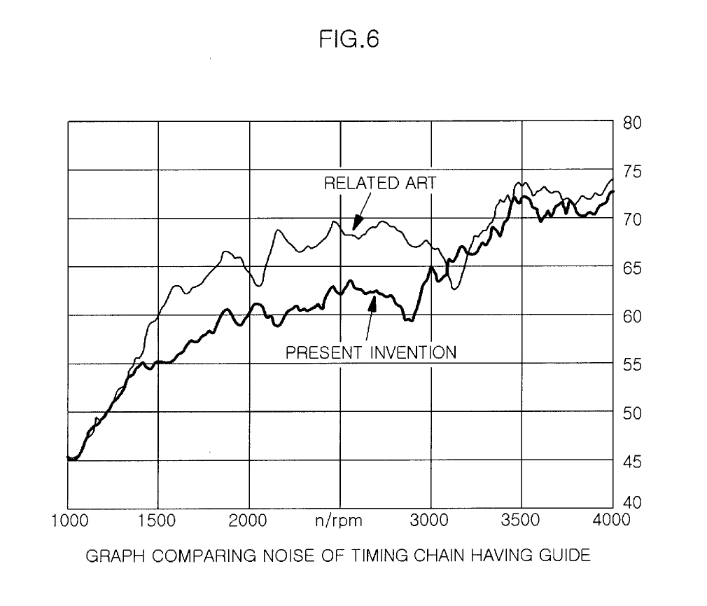

Since guides 10d and 11b radially supporting high-pressure pump sprocket 10 are formed as described above, guides 10d and 10b appropriately radially support the sprocket, when high-pressure pump sprocket 10 is radially vibrated by tensile force generated by rotating the timing chain, such that the engagement between the timing chain and the high-pressure pump sprocket is improved and the operational noise of the timing chain is significantly reduced, as shown in the comparative graph of FIG. 6, and as a result, the NVH performance of a vehicle is considerably improved.

On the other hand, it is possible to make the diameter of ring-shape guide 10d of the high-pressure pump sprocket larger than that of ring-shaped guide 11b of the timing chain cover such that ring-shaped guide 11b of the timing chain cover is inserted inside ring-shaped guide 10d of the high-pressure pump sprocket.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A noise reducing device for a timing chain of a diesel engine having:
a first guide formed on a high-pressure pump sprocket and preventing radial vibration of the high-pressure pump sprocket engaged with the timing chain to transmit rotational power of the timing chain to a high-pressure pump driving shaft; and
a second guide formed on a timing chain cover to interact with the first guide;
wherein the first and second guides are formed in a ring shape and any one of the first and second guides is inserted inside the other guide thereof with a gap therebetween; and
wherein the first guide is protruded in opposite direction against a protruding direction of the high pressure pump shaft; and
wherein the second guide is protruded in the same direction of the protruding direction of the high-pressure pump driving shaft.

2. (canceled)

3. The noise reducing device for the timing chain of the diesel engine as defined in claim 1, wherein the second guide of the timing chain cover is larger in diameter than the first guide of the high-pressure pump sprocket.

4. The noise reducing device for the timing chain of the diesel engine as defined in claim 1, wherein the timing chain cover is equipped with an oil jet pipe to supply lubricant to the gap.
